(19) United States
(12) Patent Application Publication
(10) Pub. No.: US 2017/0023262 A1
(43) Pub. Date: Jan. 26, 2017

(54) DOMESTIC HOOD

(71) Applicant: ELICA S.P.A., FABRIANO (AN) (IT)

(72) Inventors: MARCO CIMINO, TERAMO (IT); EMANUELE SPINACI, FABRIANO (IT)

(21) Appl. No.: 15/302,261

(22) PCT Filed: Mar. 26, 2015
(86) PCT No.: PCT/IB2015/052237

§ 371 Date: Oct. 6, 2016

(30) Foreign Application Priority Data
Apr. 7, 2014 (IT) MI2014A000638

(51) Int. Cl. F24C 15/20; F21V 21/096; F21V 23/06

(52) U.S. Cl. CPC F24C 15/2064; F21V 23/06; F21V 21/096; F21Y 2115/10

(57) ABSTRACT

The present disclosure relates to a hood (1) for domestic use, which comprises a support frame (10) with a power input (11), a motor fan unit (20) located within said support frame (10), lighting means (30) comprising an enclosure (33) that defines a seat (33a) containing a plate (32) having a plurality of LEDs (31), fixing means (40) for removably fixing said lighting means (30) to said support frame (10), electric connection means (60) for electrically connecting said lighting means (30) to said power input (11). The hood is characterized in that the fixing means (40) comprise at least one magnetic element (41) and at least one metal element (42) which are located on said support frame (10) and said lighting means (30) respectively, or vice versa and that said lighting means are movable relative to said support frame (10) between a first position, in which said electric connection means (60) electrically connect said lighting means (30) to said power input (11) and a second position, in which said lighting means (30) are electrically disconnected from said power input (11), wherein said electric connection means (60) are configured to electrically disconnect said lighting means (30) from said power input (11) directly, once said lighting means (30) have moved from said first position to said second position.

### FIELD OF THE INVENTION

The present disclosure relates to a hood for domestic use as defined in the preamble of claim 1.

### DISCUSSION OF THE RELATED ART

Domestic hoods are known, which may be either filter or extractor hoods, and have lighting members required for lighting the food preparation/cooking area.

For this purpose, the lighting members have a frame that may be possibly equipped with a shield having one or more lighting devices there behind, such as incandescent, neon or LED lamps.

These lighting members are powered by appropriate electric connection means, which are designed to electrically connect the lighting devices to the input section of a power circuit, which is held within the hood frame.

Particularly, these lighting devices are in such arrangement that the light beam emitted thereby can illuminate the cooktop area.

Due to their position, these lighting devices are impinged upon by the gas flow extracted by the motor fan unit located within the hood frame and the gases are filtered by a filter unit located downstream from said lighting means.

Due to their nature, gases tend to deposit a layer of grease on the screen, if any, thereby reducing the lighting capacity.

Thus, the user is required to clean the lighting members and the filter unit.

For this purpose, in such domestic hoods both the lighting means and the filter unit are designed to be removable from the hood frame.

### PRIOR ART PROBLEM

The removal of the filter unit requires the lighting means to be removed first. This is not always easy and safe for the user because the removal of the lighting means always requires the user to directly act, by his/her hands or using special tools, on the electric connection means, even though they have a low voltage, e.g. 24 Volt.

EP 1729068 discloses a wall-mounted combination extractor fan and light unit. Particularly, the user can only access the motor within its enclosure by first removing the lamp shields, then unscrewing the lamp from its support and removing the support from the enclosure, as the shield, the lamp and the support are individually movable elements that cannot be removed as an assembly. Therefore, EP 1729068 does not disclose a one-step removal of the assembly composed of the shield, the lamp and the support with simultaneous electric disconnection, with the user not being required to perform additional steps.

### SUMMARY OF THE INVENTION

The above described prior art clearly shows that a need is strongly felt by hood manufacturers for simple and quicker removal of the lighting means by the user, without the need of electrically disconnecting such lighting means from the power source, by hand or using tools.

### ADVANTAGES OF THE INVENTION

According to the present invention, this object is fulfilled by a hood as defined in claim 1.

With the present invention, the lighting means can be removed from the hood frame by exerting such a pull force as to release the electric connection with the input section of the power circuit. Thus, the lighting means can be directly and electrically insulated upon removal thereof.

Furthermore, with the present invention, the user may remove the lighting means without having to act upon the electric connections.

### BRIEF DESCRIPTION OF THE DRAWINGS

The characteristics and advantages of the present disclosure will appear from the following detailed description of a possible practical embodiment, illustrated as a non-limiting example in the set of drawings, in which:

FIG. 1 shows a perspective view of a domestic of the present invention;

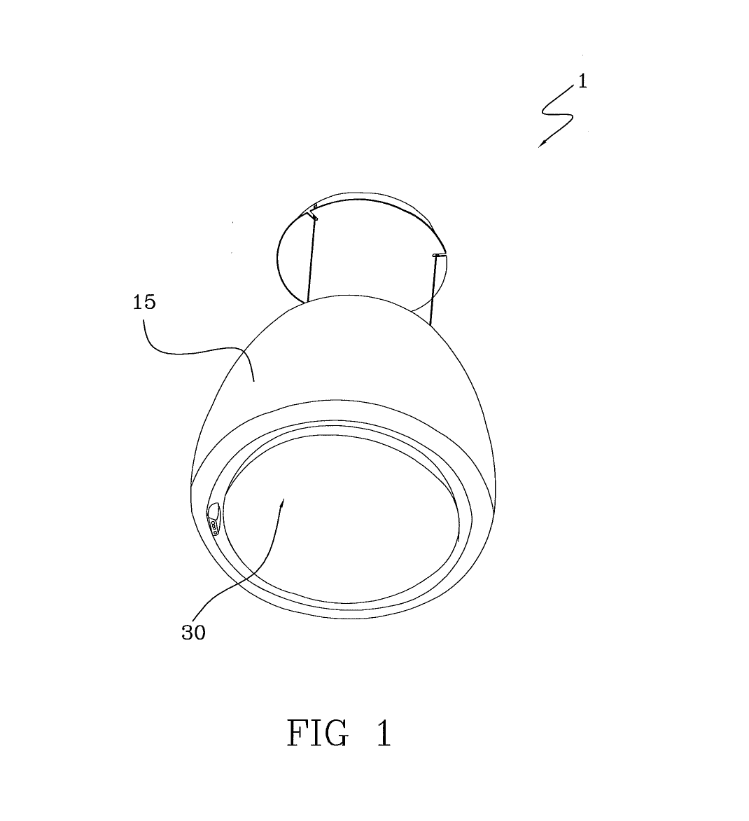

FIG. 2 shows a partially sectional side view of the hood of FIG. 1;

FIG. 3 shows a partially sectional perspective view of the lighting means of the present invention;

FIG. 4 shows a sectional view of the lighting means associated with the hood frame of the present invention;

FIG. 5 shows a sectional view of the lighting means removed from the hood frame of the present invention.

### DETAILED DESCRIPTION

Referring to the accompanying figures, numeral 1 designates a hood for domestic use.

The hood 1 extends along a main longitudinal direction X-X and comprises a support frame 10, a motor fan unit 20 located within the frame 10 and supported thereby, as well as lighting means 30.

The support frame 10 extends between a lower end portion 2 and an upper end portion 3.

At the lower end portion 2, the hood 1 has a suction port 4 in fluid communication with the motor fan unit 20.

Filter means 50 are arranged between the suction port 4 and the motor fan unit 20, and are configured to filter the gases extracted by the motor fan unit 20 through the suction port 4.

The hood 1 also comprises a protective enclosure 15 which is disposed outside the support frame 19 to enclose the support frame 10, the motor fan unit 20 and the filter means 50.

At the upper end portion 3, the hood 1 has an exhaust port 5 in fluid communication with the motor fan unit 20.

The frame 10 has a power input 11 through which the hood 1 may be connected to the mains, to supply power to the motor fan unit 20 and the lighting means 30.

In the example of the annexed figures, the power input 11 is located at the upper end 3.

The input 11 is connected via respective power lines to the power input (not shown) of the motor fan unit 20 and, via means to be later described in detail, to the lighting means 30.

The lighting means 30 are removably fixed to the support frame 10 and are movable relative to the support frame 10, preferably in the longitudinal direction X-X. For this purpose, the hood 1 comprises fixing means 40 for removably fixing the lighting means 30 to the support frame 10.

The hood 1 further comprises electric connection means 60 for electrically connecting the lighting means 30 to the power input 11.

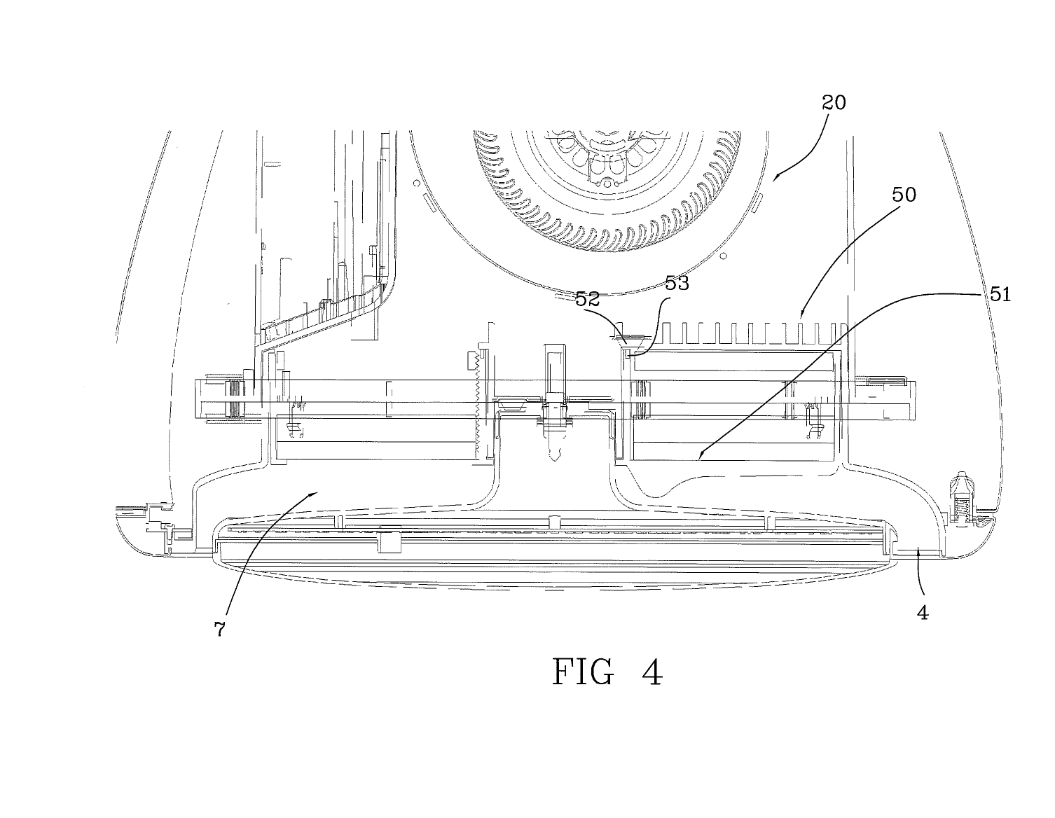

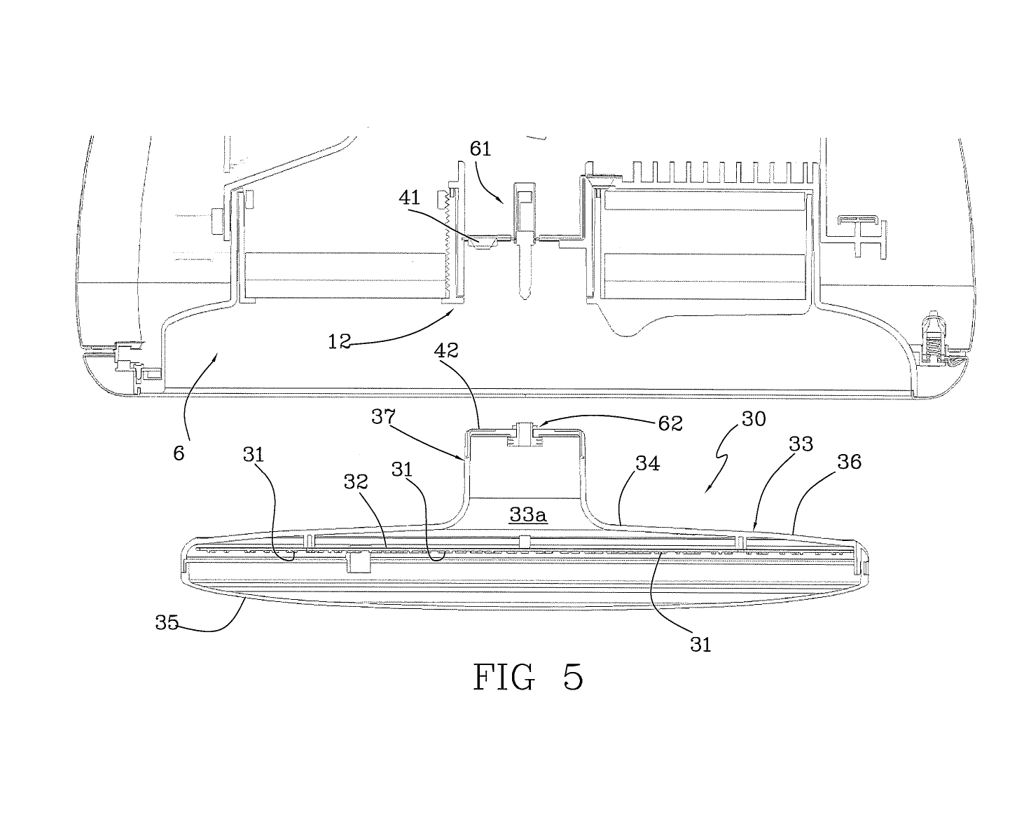

The lighting means 30 are movable relative to the support frame 10 between a first position (see FIG. 4) in which the electric connection means 60 electrically connect the lighting means 30 to the power input 11, and a second position (see FIG. 5) in which the lighting means 30 are electrically disconnected from the power input 11, i.e. with no additional step.

Particularly, the electric connection means 60 are configured to electrically disconnect the lighting means 30 from the power input 30 directly, once the lighting means 30 have moved from the first position to the second position. This will afford electric insulation of the lighting means 30 as soon as the lighting means 30 are removed for access to the interior of the support frame 10, e.g. for replacing the filter means. Such electric insulation of the lighting means 30 allows the user to access the filter means 50 without risking any contact with live elements.

According to one embodiment, the filter means 50 are housed in a filter holder 51 which is removably fixed to the support frame 10. Advantageously, the filter holder 51 is removably fixed to the support frame 10 by magnetic coupling. For example, the support frame 10 may be equipped with one or more magnetic elements 52 which hold a metal element 53 embedded in the filter holder 51 or stably fixed thereto.

According to one embodiment, the electric connection means 60 include first contact means 61 arranged on the frame 10 and rigidly joined thereto and second contact means 62 arranged on the lighting means 30 and rigidly joined thereto. Therefore, as said second contact means 62 move from the first position to the second position, they move with said lighting means 30.

In the first position, the first contact means 61 contact the second contact means 62 to electrically connect the lighting means 30 to the power input 11, whereas in the second position the second contact means 62 are electrically disconnected from the first contact means 61 to electrically insulate the lighting means 30.

The first contact means 61 are connected via a power line (not shown) to the power input 11.

In this example, the power line is placed in a cable guide 13 which is rigidly joined to the support frame 10.

In one embodiment, the first contact means 61 comprise at least one male terminal, in this example a single male terminal which preferably extends in the longitudinal direction X-X. This will facilitate the movement of the lighting means 30 in this longitudinal direction X-X from the first position to the second position and vice versa.

The second contact means 62 comprise at least one female terminal, in this example a single female terminal, which is configured to receive and be coupled with a respective male terminal 61 (see FIGS. 4 and 5).

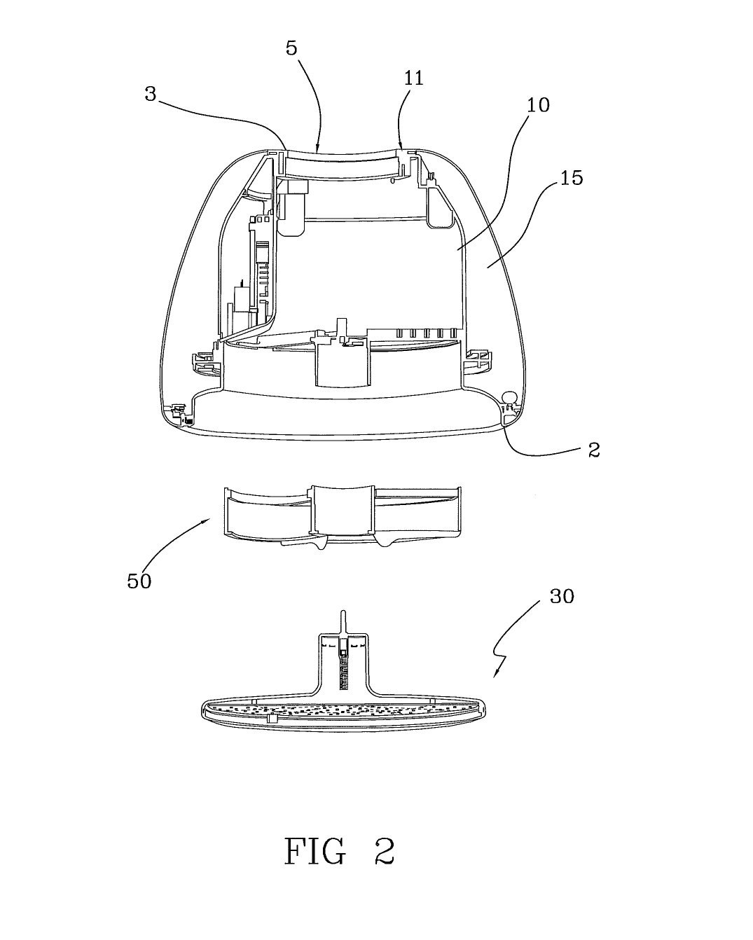

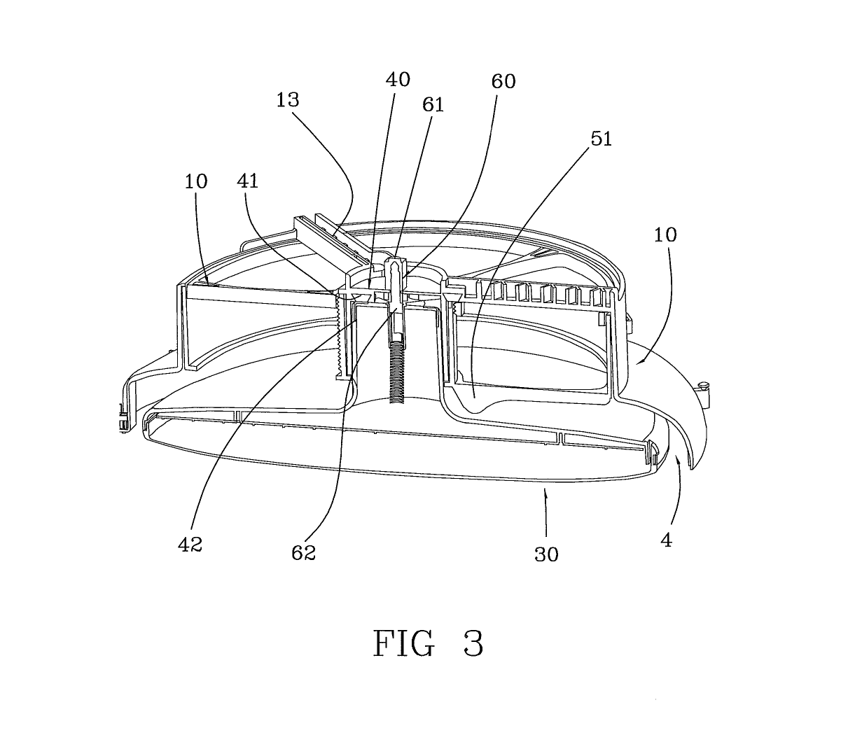

Alternatively, the first contact means 61 comprise a female terminal and the second contact means 62 comprise a male terminal (see FIGS. 2 and 3).

In one embodiment, the lighting means 30 are situated at the lower end portion 2 of the frame 10, hence upstream from the filter means 50. In order to accommodate the lighting means 30, the frame 10 has a seat 6 at the lower end portion 2. This seat 6 is designed to receive the lighting means 30 such that, in the first position—corresponding to the operating position—the lighting means 30 form a gap with the perimeter portion of the seat 6.

This gap defines the suction port 4 and allows the user to easily remove the lighting means 30. This is because, due to this gap, the user can access the lateral portion of the lighting means 30 and manually take hold of the lighting means 30 to move them from the first position to the second position.

In one embodiment, the lighting means 30 comprise an enclosure 33 that defines a seat 33a containing a plate 32 having a plurality of LEDs 31.

Nevertheless, in FIGS. 4 and 5 the enclosure 33 that defines the seat 33a containing the plate 32 having the plurality of LEDs 31 is itself movable relative to the support frame 10 between the first position (FIG. 4) and the second position (FIG. 5), in which the LEDs 31 are electrically disconnected from the power input 11.

The LEDs 31 are connected to the second contact means 62.

The enclosure 33 has an upper portion 34 and a lower portion 35.

The second contact means 62 are located in the upper portion 34 and are connected to the LEDs 31. Particularly, the upper portion 34 has an annular part 36 and a central part 37 that projects from the plane of the annular part 36 along the longitudinal direction X-X. The second contact means 62 are located at the upper portion of the central part 37. In this embodiment, the first contact means 61 are arranged in a central part 12 of the support frame 10, which is configured to face the central part 37 of the lighting means 30 in the first position.

Advantageously, the lower portion 33 and the upper portion 34 are removably attached to each other, in this example, by clip-on fastening members, for the LEDs 31 to be accessed and replaced in case of failure.

The lower portion 33 may be transparent or opaque, according to the desired illumination intensity.

In order to allow air to flow from the suction port 4 to the motor fan unit 20, the upper portion 34 of the lighting means 30 is spaced from the filter means 50 to thereby define an annular channel 7 (which is known as perimeter extraction) providing fluid communication between the gap 4, i.e. the suction port of the hood 1 and the filter means 50. This annular channel 7 also assists the user in taking hold of the lighting means 30 when the latter are in the first position, by allowing him/her to insert the end portions of his/her fingers both in the gap 4 and in the annular channel 6 above it.

The fixing means 40 are also movable between a first position, in which they hold the lighting means 30 attached to the support frame 10 and a second position, in which the lighting means 30 are disengaged from the support frame 10.

In one embodiment, the electric connection means 60 may be configured to also act as fixing means 40. In this case, the first and second positions of the fixing means 40 correspond to the first and second positions of the electric connection means 60 respectively. Therefore, the lighting means 30 are disengaged from the support frame 10 and electrically disconnected from the power input 11 substantially at the same time.

Nevertheless, advantages are derived from using the embodiment in which the electric connection means 60 are distinct from the fixing means 40 and define respective second positions, whereby the lighting means 30 are disengaged from the support frame 10 and are electrically disconnected from the power input 11 at distinct times during removal of the lighting means from the hood 1.

In one embodiment, the fixing means 40 comprise at least one magnetic element 41 and at least one metal element 42, which are located on said support frame 10 and said lighting means 30 respectively, or vice versa,

In the first position, the magnetic element 41 holds the metal element 42 to keep the lighting means 30 attached to the support frame 10.

In a second position of the fixing means 40, the metal element 42 disengages from the magnetic element 41. Thus, the metal element 42 disengages from the magnetic element 41 as the lighting means move from the first position to the second position.

In this example, the fixing means 40 comprise three magnetic elements 41 arranged on the support frame 10, at an angular distance of 120° from each other.

The metal element 42 is embedded in the enclosure 33 of the lighting means 30, particularly in its central part 37. Alternatively, the metal element 42 may be stably attached to the enclosure 33.

Due to the use of magnetic elements, the lighting means 30 move toward the second position, a magnetic gap is formed between the magnetic elements 41 and the metal element 42. The formation of such magnetic gap allows the lighting means 30 to be disengaged from the support frame 10 but still electrically connected to the power input 11 via the electric connection means 60. This electric connection is broken when the lighting means 30 are in the second position.

Those skilled in the art will obviously appreciate that a number of changes and variants may be made to the above described hood, to fulfill particular requirements, without departure from the scope of the invention, as defined in the following claims.

1. A domestic hood comprising:
a support frame with a power input,
a motor fan unit located within said support frame,
said support frame extends between a lower end portion and an upper end portion at said lower end portion, the hood has a suction port in fluid communication with the motor fan unit;
filter means arranged between the suction port and said motor fan unit and configured to filter gases extracted by the motor fan unit through the suction port;
lighting means comprise an enclosure that defines a seat containing a plate having a plurality of LEDs,
fastener means for removably fixing said lighting means to said support frame,
electric connection means for electrically connecting said lighting means to said power input,
characterized in that
said fastener means comprise at least one magnetic element and at least one metal element, which are placed on said support frame and said lighting means respectively, or vice versa,
said lighting means are situated at the lower end portion of said frame upstream from the filter means,
said lighting means being movable relative to said support frame between a first position, in which said electric connection means electrically connect said lighting means to said power input and a second position, in which said lighting means are electrically disconnected from said power input so as to access to the interior of said support frame for replacing said filter means,
said electric connection means are configured to electrically disconnect said lighting means from said power input without any intermediate step, once said lighting means have moved from said first position to said second position.

2. The domestic hood as claimed in claim 1, wherein:
in said first position, said at least one magnetic element holds said at least one metal element to keep said lighting means attached to said support frame,
in said second position, said at least one metal element is released from said at least one magnetic element.

3. The domestic hood as claimed in claim 1, wherein said at least one metal element disengages from said at least one magnetic element as said lighting means move from said first position to said second position.

4. The domestic hood as claimed in claim 1, wherein:
said electric connection means comprise first contact means arranged on said support frame and second contact means arranged on said lighting means,
as said second contact means move from the first position to the second position, they move with said lighting means,
in said first position, said first contact means contact said second contact means to electrically connect said lighting means to said power input,
in the second position, said second contact means are electrically disconnected from said first contact means to electrically insulate said lighting means.

5. The domestic hood as claimed in claim 4, wherein:
said first contact means comprise at least one male terminal,
said second contact means comprise at least one female terminal, said at least one female terminal being configured to receive and be coupled with a respective male terminal of the first contact means.

6. The domestic hood as claimed in claim 4, wherein:
said first contact means comprise at least one female terminal,
said second contact means comprise at least one male terminal, said at least one male terminal being configured to be coupled with a respective female terminal of the first contact means.
